(19) United States
(12) Patent Application Publication
(10) Pub. No.: US 2025/0246013 A1
(43) Pub. Date: Jul. 31, 2025

(54) PRODUCT-INCLUSIVE IMAGE ALT TEXT GENERATION

(71) Applicant: Walmart Apollo, LLC, Bentonville, AR (US)

(72) Inventors: Tong Yao, San Jose, CA (US); Zigeng Wang, Santa Clara, CA (US); Wei Shen, Pleasanton, CA (US)

(73) Assignee: Walmart Apollo, LLC, Bentonville, AR (US)

(21) Appl. No.: 19/041,244

(22) Filed: Jan. 30, 2025

Related U.S. Application Data
(60) Provisional application No. 63/627,046, filed on Jan. 30, 2024.

(51) Int. Cl. G06V 20/70; G06V 30/19

(52) U.S. Cl. CPC G06V 20/70; G06V 30/19093

(57) ABSTRACT

A method can be implemented via execution of computing instructions configured to run at a processor. The method can include: receiving, from a user, an image of a product; receiving, from the user, user-submitted logo alt text describing a brand of the product in the image; receiving, from the user, user-submitted image alt text describing the image; extracting brand information from the user-submitted logo alt text; extracting product information from the user-submitted image alt text; generating an instruction prompt that includes the brand information, as extracted, and the product information, as extracted; and generating a recommended image alt text describing the image and including the brand information, as extracted, and the product information, as extracted, by querying a multimodal generative artificial intelligence (multimodal GenAI) model with the instruction prompt. Other embodiments are disclosed.

### CROSS-REFERENCE TO RELATED APPLICATIONS

This application claims priority to U.S. Provisional Application No. 63/627,046 filed on Jan. 30, 2024, which is incorporated by reference herein in its entirety for all purposes.

### FIELD OF THE DISCLOSURE

The present disclosure generally relates to generating text to describe images.

### BACKGROUND

Manual creation of text descriptions for images are costly and time consuming. Software-creation of text descriptions for images are often limited to simple images with plain backgrounds, and also are often inaccurate. Accordingly, a need exists for more accurate, cost-effective, and less-time consuming systems and methods to provide text descriptions for images.

### BRIEF DESCRIPTION OF THE DRAWINGS

To facilitate further description of the embodiments, the following drawings are provided in which:

FIG. 1 illustrates a front elevation view of one or more computer systems that are suitable for implementing at least a portion of an embodiment of the system disclosed in FIG. 3;

FIG. 2 illustrates a representative block diagram of an example of elements included in circuit boards inside the chassis of the computer system of FIG. 1;

FIG. 3 illustrates a system for generating text for an image, according to one embodiment;

FIG. 4 illustrates an example of an image used for use in an advertisement on an e-commercial retail website, according to an embodiment;

FIG. 5A illustrates a flow chart for a method of training a multimodal GenAI model to generate text, according to an embodiment;

FIGS. 5B and 5C illustrate examples of test images and the test text generated by the method in FIG. 5A, according to an embodiment;

FIG. 6 illustrates a flow chart for a method of generating text, according to an embodiment,

FIG. 7 illustrates a flow chart for a method of generating an instruction prompt, according to an embodiment;

FIG. 8A illustrates a flow chart for a method of post-processing the recommended text, according to an embodiment;

FIG. 8B illustrates an example of a user-submitted image and user-submitted text;

FIG. 9 illustrates a chart comparing generated text with other text generated by other systems and methods, according to an embodiment;

FIG. 10 illustrates images of other possible uses of the systems and methods described herein, according to an embodiment;

FIG. 11 illustrates an image of another possible use of the systems and methods described herein, according to an embodiment; and

FIG. 12 illustrates a flow chart for a method of generating text, according to an embodiment.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real-time” encompasses operations that occur in “near” real-time or somewhat delayed from a triggering event. In a number of embodiments, “real-time” can mean real-time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately 0.1 second, 0.5 second, one second, two seconds, five seconds, or ten seconds.

### DETAILED DESCRIPTION

In some embodiments, a system can include a processor and a non-transitory computer-readable media storing computing instructions. When executed on the processor, the computing instructions can cause the processor to perform: receiving, from a user, an image of a product; receiving, from the user, user-submitted logo alt text describing a brand of the product in the image; receiving, from the user, user-submitted image alt text describing the image; extracting brand information from the user-submitted logo alt text; extracting product information from the user-submitted image alt text; generating an instruction prompt that includes the brand information, as extracted, and the product information, as extracted; and generating a recommended image alt text describing the image and including the brand information, as extracted, and the product information, as extracted, by querying a multimodal generative artificial intelligence (multimodal GenAI) model with the instruction prompt.

In other embodiments, a method can be implemented via execution of computing instructions configured to run at a processor. The method can include: receiving, from a user, an image of a product; receiving, from the user, user-submitted logo alt text describing a brand of the product in the image; receiving, from the user, user-submitted image alt text describing the image; extracting brand information from the user-submitted logo alt text; extracting product information from the user-submitted image alt text; generating an instruction prompt that includes the brand information, as extracted, and the product information, as extracted; generating a recommended image alt text describing the image and including the brand information, as extracted, and the product information, as extracted, by querying a multimodal generative artificial intelligence (multimodal GenAI) model with the instruction prompt; and validating the recommended image alt text generated by the multimodal GenAI model.

In further embodiments, a non-transitory computer readable storage medium can store computing instructions. When run on a processor, the computing instructions can cause the processor to perform operations including: receiving, from a user, an image of a product; receiving, from the user, user-submitted logo alt text describing a brand of the product in the image; receiving, from the user, user-submitted image alt text describing the image; extracting brand information from the user-submitted logo alt text; extracting product information from the user-submitted image alt text; generating an instruction prompt that includes the brand information, as extracted, and the product information, as extracted; generating a recommended image alt text describing the image and including the brand information, as extracted, and the product information, as extracted, by querying a multimodal generative artificial intelligence (multimodal GenAI) model with the instruction prompt; and validating the recommended image alt text generated by the multimodal GenAI model by: comparing the recommended image alt text generated by the multimodal GenAI model to the user-submitted image alt text to generate a comparison result; and selecting one of the recommended image alt text or the user-submitted image alt text, based on the comparison result.

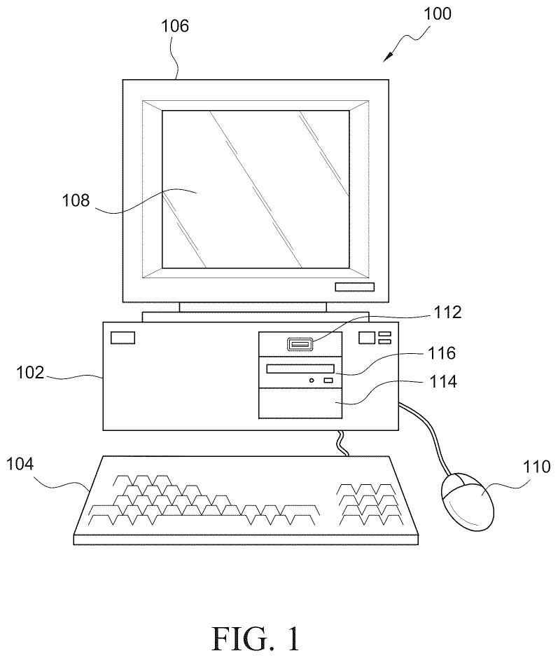

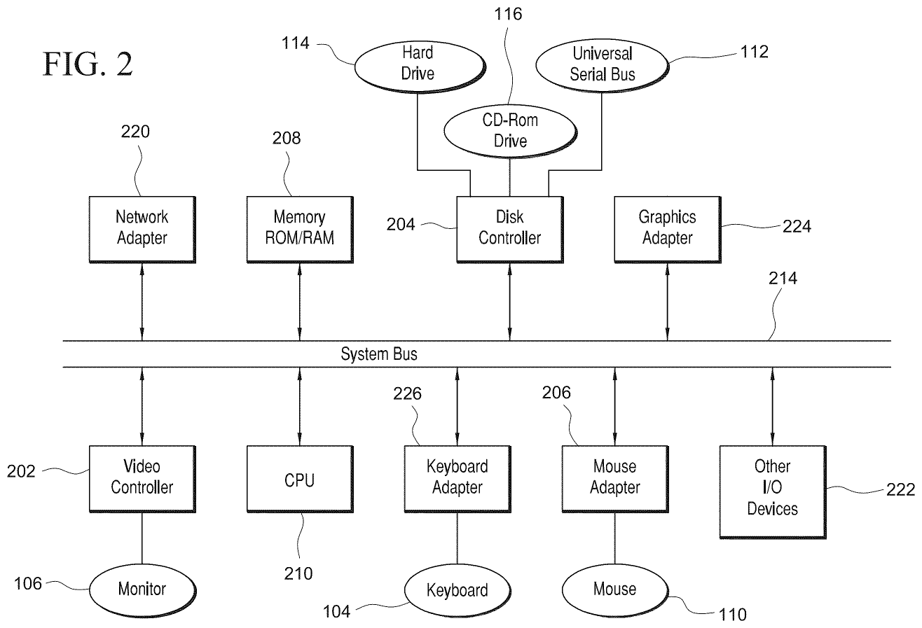

Turning to the drawings, FIG. 1 illustrates an exemplary embodiment of a computer system 100, all of which or a portion of which can be suitable for (i) implementing part or all of one or more embodiments of the techniques, methods, and systems and/or (ii) implementing and/or operating part or all of one or more embodiments of the non-transitory computer readable media described herein. As an example, a different or separate one of computer system 100 (and its internal components, or one or more elements of computer system 100) can be suitable for implementing part or all of the techniques described herein. Computer system 100 can comprise chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to memory storage unit 208 that includes both read only memory (ROM) and random access memory (RAM). Non-volatile portions of memory storage unit 208 or the ROM can be encoded with a boot code sequence suitable for restoring computer system 100 (FIG. 1) to a functional state after a system reset. In addition, memory storage unit 208 can include microcode such as a Basic Input-Output System (BIOS). In some examples, the one or more memory storage units of the various embodiments disclosed herein can include memory storage unit 208, a USB-equipped electronic device (e.g., an external memory storage unit (not shown) coupled to universal serial bus (USB) port 112 (FIGS. 1-2)), hard drive 114 (FIGS. 1-2), and/or CD-ROM, DVD, Blu-Ray, or other suitable media, such as media configured to be used in CD-ROM and/or DVD drive 116 (FIGS. 1-2). Non-volatile or non-transitory memory storage unit(s) refer to the portions of the memory storage units(s) that are non-volatile memory and not a transitory signal. In the same or different examples, the one or more memory storage units of the various embodiments disclosed herein can include an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Exemplary operating systems can include one or more of the following: (i) Microsoft® Windows® operating system (OS) by Microsoft Corp. of Redmond, Washington, United States of America, (ii) Mac® OS X by Apple Inc. of Cupertino, California, United States of America, (iii) UNIX® OS, and (iv) Linux® OS. Further exemplary operating systems can comprise one of the following: (i) the iOS® operating system by Apple Inc. of Cupertino, California, United States of America, (ii) the WebOS operating system by LG Electronics of Seoul, South Korea, (iii) the Android™ operating system developed by Google, of Mountain View, California, United States of America, or (iv) the Windows Mobile™ operating system by Microsoft Corp. of Redmond, Washington, United States of America.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 210.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to a keyboard 104 (FIGS. 1-2) and a mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for refreshing a monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM and/or DVD drive 116 (FIGS. 1-2). In other embodiments, distinct units can be used to control each of these devices separately.

In some embodiments, network adapter 220 can comprise and/or be implemented as a WNIC (wireless network interface controller) card (not shown) plugged or coupled to an expansion port (not shown) in computer system 100 (FIG. 1). In other embodiments, the WNIC card can be a wireless network card built into computer system 100 (FIG. 1). A wireless network adapter can be built into computer system 100 (FIG. 1) by having wireless communication capabilities integrated into the motherboard chipset (not shown), or implemented via one or more dedicated wireless communication chips (not shown), connected through a PCI (peripheral component interconnector) or a PCI express bus of computer system 100 (FIG. 1) or USB port 112 (FIG. 1). In other embodiments, network adapter 220 can comprise and/or be implemented as a wired network interface controller card (not shown).

Although many other components of computer system 100 (FIG. 1) are not shown, such components and their interconnection are well known to those of ordinary skill in the art. Accordingly, further details concerning the construction and composition of computer system 100 (FIG. 1) and the circuit boards inside chassis 102 (FIG. 1) are not discussed herein.

When computer system 100 in FIG. 1 is running, program instructions stored on a USB drive in USB port 112, on a CD-ROM or DVD in CD-ROM and/or DVD drive 116, on hard drive 114, or in memory storage unit 208 (FIG. 2) are executed by CPU 210 (FIG. 2). A portion of the program instructions, stored on these devices, can be suitable for carrying out all or at least part of the techniques described herein. In various embodiments, computer system 100 can be reprogrammed with one or more modules, system, applications, and/or databases, such as those described herein, to convert a general purpose computer to a special purpose computer. For purposes of illustration, programs and other executable program components are shown herein as discrete systems, although it is understood that such programs and components may reside at various times in different storage components of computer system 100, and can be executed by CPU 210. Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs.

Although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile device, such as a smartphone. In certain additional embodiments, computer system 100 may comprise an embedded system.

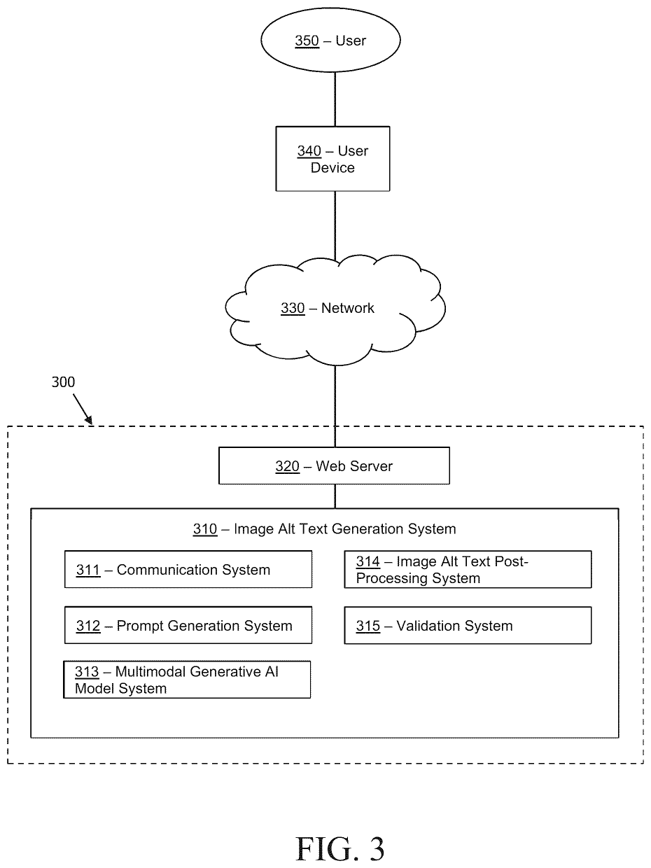

Turning ahead in the drawings, FIG. 3 illustrates a block diagram of a system 300 that can be employed for product-inclusive image alt text generation, according to an embodiment. System 300 is merely exemplary and embodiments of the system are not limited to the embodiments presented herein. The system can be employed in many different embodiments or examples not specifically depicted or described herein. In some embodiments, certain elements, modules, or systems of system 300 can perform various procedures, processes, and/or activities. In other embodiments, the procedures, processes, and/or activities can be performed by other suitable elements, modules, or systems of system 300. In some embodiments, system 300 can include an image alt text generation system 310 and/or a web server 320.

Generally, therefore, system 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 described herein.

Image alt text generation system 310 and/or web server 320 can each be a computer system, such as computer system 100 (FIG. 1), as described above, and can each be a single computer, a single server, or a cluster or collection of computers or servers, or a cloud of computers or servers. In another embodiment, a single computer system can host image alt text generation system 310 and/or web server 320. Additional details regarding image alt text generation system 310 and/or web server 320 are described herein.

In some embodiments, web server 320 can be in data communication through a network 330 with one or more user devices, such as a user device 340. User device 340 can be part of system 300 or external to system 300. Network 330 can be the Internet or another suitable network. In some embodiments, user device 340 can be used by users, such as a user 350. In many embodiments, web server 320 can host one or more websites and/or mobile application servers. For example, web server 320 can host a website, or provide a server that interfaces with an application (e.g., a mobile application), on user device 340, which can allow users (e.g., 350) to browse and/or search for items (e.g., products, grocery items), to add items to an electronic cart, and/or to purchase items, in addition to other suitable activities, or to interface with and/or configure image alt text generation system 310.

In some embodiments, an internal network that is not open to the public can be used for communications between image alt text generation system 310 and web server 320 within system 300. Accordingly, in some embodiments, image alt text generation system 310 (and/or the software used by such systems) can refer to a back end of system 300 operated by an operator and/or administrator of system 300, and web server 320 (and/or the software used by such systems) can refer to a front end of system 300, as is can be accessed and/or used by one or more users, such as user 350, using user device 340. In these or other embodiments, the operator and/or administrator of system 300 can manage system 300, the processor(s) of system 300, and/or the memory storage unit(s) of system 300 using the input device(s) and/or display device(s) of system 300.

In certain embodiments, the user devices (e.g., user device 340) can be desktop computers, laptop computers, mobile devices, and/or other endpoint devices used by one or more users (e.g., user 350). A mobile device can refer to a portable electronic device (e.g., an electronic device easily conveyable by hand by a person of average size) with the capability to present audio and/or visual data (e.g., text, images, videos, music, etc.). For example, a mobile device can include at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device, or another portable computer device with the capability to present audio and/or visual data (e.g., images, videos, music, etc.). Thus, in many examples, a mobile device can include a volume and/or weight sufficiently small as to permit the mobile device to be easily conveyable by hand. For examples, in some embodiments, a mobile device can occupy a volume of less than or equal to approximately 1790 cubic centimeters, 2434 cubic centimeters, 2876 cubic centimeters, 4056 cubic centimeters, and/or 5752 cubic centimeters. Further, in these embodiments, a mobile device can weigh less than or equal to 15.6 Newtons, 17.8 Newtons, 22.3 Newtons, 31.2 Newtons, and/or 44.5 Newtons.

Exemplary mobile devices can include (i) an iPod®, iPhone®, iTouch®, iPad®, MacBook® or similar product by Apple Inc. of Cupertino, California, United States of America, (ii) a Lumia® or similar product by the Nokia Corporation of Keilaniemi, Espoo, Finland, and/or (iii) a Galaxy™ or similar product by the Samsung Group of Samsung Town, Seoul, South Korea. Further, in the same or different embodiments, a mobile device can include an electronic device configured to implement one or more of (i) the iPhone® operating system by Apple Inc. of Cupertino, California, United States of America, (ii) the Android™ operating system developed by the Open Handset Alliance, or (iii) the Windows Mobile™ operating system by Microsoft Corp. of Redmond, Washington, United States of America.

In many embodiments image alt text generation system 310 and/or web server 320 can each include one or more input devices (e.g., one or more keyboards, one or more keypads, one or more pointing devices such as a computer mouse or computer mice, one or more touchscreen displays, a microphone, etc.), and/or can each comprise one or more display devices (e.g., one or more monitors, one or more touch screen displays, projectors, etc.). In these or other embodiments, one or more of the input device(s) can be similar or identical to keyboard 104 (FIG. 1) and/or a mouse 110 (FIG. 1). Further, one or more of the display device(s) can be similar or identical to monitor 106 (FIG. 1) and/or screen 108 (FIG. 1). The input device(s) and the display device(s) can be coupled to image alt text generation 310 and/or web server 320 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processor(s) and/or the memory storage unit(s). In some embodiments, the KVM switch also can be part of image alt text generation system 310 and/or web server 320. In a similar manner, the processors and/or the non-transitory computer-readable media can be local and/or remote to each other.

Meanwhile, in many embodiments, image alt text generation system 310 and/or web server 320 also can be configured to communicate with one or more databases. The one or more databases can include a product database that contains information about products, items, or SKUs (stock keeping units), for example, among other information, such as browse shelves, as described below in further detail. The one or more databases can be stored on one or more memory storage units (e.g., non-transitory computer readable media), which can be similar or identical to the one or more memory storage units (e.g., non-transitory computer readable media) described above with respect to computer system 100 (FIG. 1). Also, in some embodiments, for any particular database of the one or more databases, that particular database can be stored on a single memory storage unit or the contents of that particular database can be spread across multiple ones of the memory storage units storing the one or more databases, depending on the size of the particular database and/or the storage capacity of the memory storage units.

The one or more databases can each include a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, and IBM DB2 Database.

Meanwhile, image alt text generation system 310, web server 320, and/or the one or more databases can be implemented using any suitable manner of wired and/or wireless communication. Accordingly, system 300 can include any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can include Bluetooth, Zigbee, Wireless Universal Serial Bus (USB), Z-Wave, etc.; exemplary LAN and/or WAN protocol(s) can include Institute of Electrical and Electronic Engineers (IEEE) 802.3 (also known as Ethernet), IEEE 802.11 (also known as WiFi), etc.; and exemplary wireless cellular network protocol(s) can include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware implemented can depend on the network topologies and/or protocols implemented, and vice versa. In many embodiments, exemplary communication hardware can include wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can include wireless communication hardware including, for example, one or more radio transceivers, one or more infrared transceivers, etc. Additional exemplary communication hardware can include one or more networking components (e.g., modulator-demodulator components, gateway components, etc.).

In many embodiments, image alt text generation system 310 can include a communication system 311, a prompt generation system 312, a multimodal generative artificial intelligence (GenAI) system 313, an image alt text post-processing system 314 and/or a validation system 315. In many embodiments, the systems of image alt text generation system 310 can be modules of computing instructions (e.g., software modules) stored at non-transitory computer readable media that operate on one or more processors. In other embodiments, the systems of image alt text generation system 310 can be implemented in hardware. Image alt text generation system 310 and/or web server 320 each can be a computer system, such as computer system 100 (FIG. 1), as described above, and can be a single computer, a single server, or a cluster or collection of computers or servers, or a cloud of computers or servers. In another embodiment, a single computer system can host image alt text generation system 310 and/or web server 320. Additional details regarding image alt text generation system 310 and the components thereof are described herein.

Image alt text is a descriptive text that is often provided on websites accompanying images that appear on that website, such as images of products being offered for sale on the websites of product retailers (e.g., ad images). The image alt text can appear adjacent images on the website, and/or can become visible when users “hover” a mouse (e.g., mouse 110 (FIGS. 1-2)) over one or more of the images, and/or can be accessed by other appropriate selection, such as via accessibility tools for visually impaired users. Image alt text can accompany images for a number of reasons, including: to improve resiliency of the website display, for example in the event an associated image fails to load; to improve visibility of the displayed product, such as for example visibility of the product to search engines (e.g. Google search engine) used by users to locate products for sale (e.g., search engine optimization (SEO)); and/or to improve accessibility to users with visual impairment, by providing descriptive text that can be read by screen-reading tools for visually impaired persons (e.g. Apple OS VoiceOver tool). In certain embodiments, the image alt text can be included in the html image information for the web page that displays the image.

The image alt text provides a description of what is visually represented in the image, such as a description of any product present in the image and optionally other additional image features that may be present in the image, such as any background visible in the image, and/or other objects and/or persons visible in the image, as well as any activities being shown in the image. Image alt text can provide context and information about image content. Examples of the types of images that can include image alt text associated therewith include lifestyle images, product images, brand shop images, logo images, department and/or category logos, and more.

In a number of embodiments, the techniques described herein can generate image alt text that includes comprehensive product information and even promotional details, as well as validate and recommend such image alt text. In certain embodiments, the techniques described herein are cost-efficient and less time-consuming than having users manually enter proposed image alt text, and requiring manual audit of the proposed user-entered image alt text. In certain further embodiments, the techniques described herein are capable of robustly including product and brand information in the generated and recommended image alt text, which improves user recognition of the product in the image and enhances SEO for the product displayed image. According to further embodiments, the techniques described herein are capable of incorporating input from users, including to provide promotional information and/or messages in the generated image alt text. According to even further embodiments, the techniques described herein are capable of generating image alt text with high diversity and accuracy.

In certain embodiments, the techniques described herein incorporate a multimodal generative artificial intelligence (GenAI) model to generate recommended image alt text, including comprehensive brand, product, and/or even promotional details. In further embodiments, the multimodal GenAI model is trained to focus on brand and product information for products shown in images, to improve generation of recommended image alt text that includes brand information and product information, and even promotional details. In certain embodiments, the recommended image alt text is directly shown to users for approval or acceptance thereof, and/or the recommended image alt text can be automatically validated and accepted.

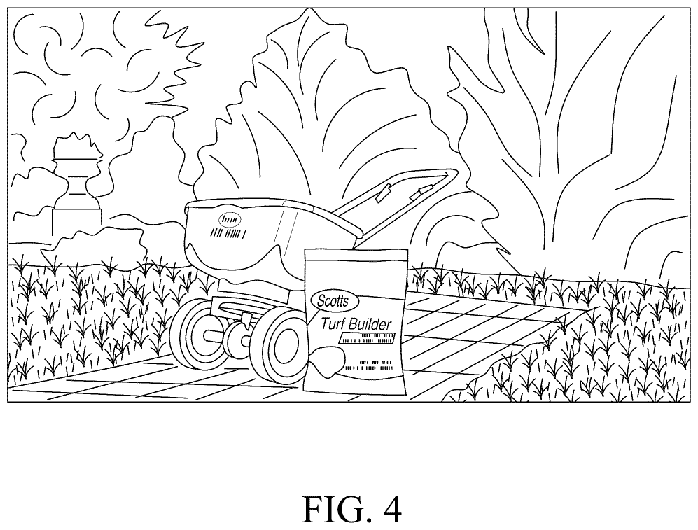

Referring to FIG. 4 of the drawings, an example of an image used for use in an advertisement on an e-commerce retail website is shown, depicting a Scotts brand winter-guard spreader and bag of fertilizer. A user (e.g., user 350 (FIG. 3)) can manually enter proposed image alt text that describes the image and products shown in the image, such as for example “Lifestyle-Scotts-Winterguard/Spreader.” While this proposed image alt text does include brand information (Scotts) and certain product information (Winterguard), it does not provide a comprehensive and/or long form description of the product, or any promotional information. Examples of recommended image alt text, such as those generated and recommended according to embodiments of techniques described herein, include improved text such as “Scotts winterguard spreader and a bag of fertilizer on a brick way” which also includes brand and product information written in a comprehensive form, and promotional information. Accordingly, embodiments of the techniques described herein are capable of generating recommendations for improved image alt text that intelligibly and comprehensively incorporate brand and product information.

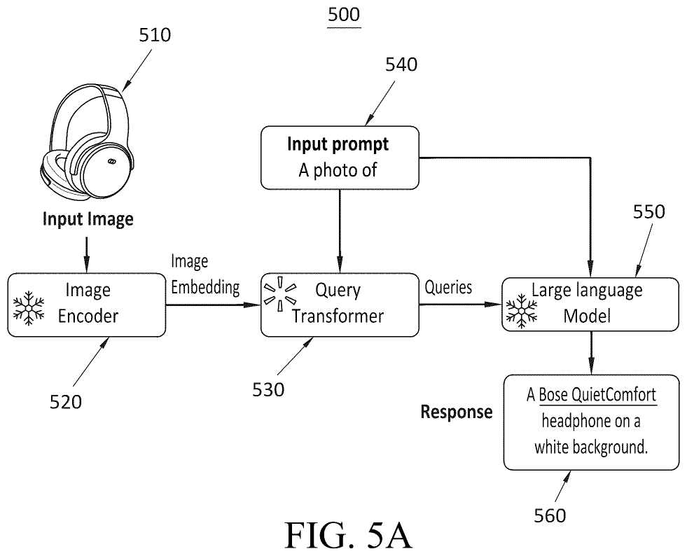

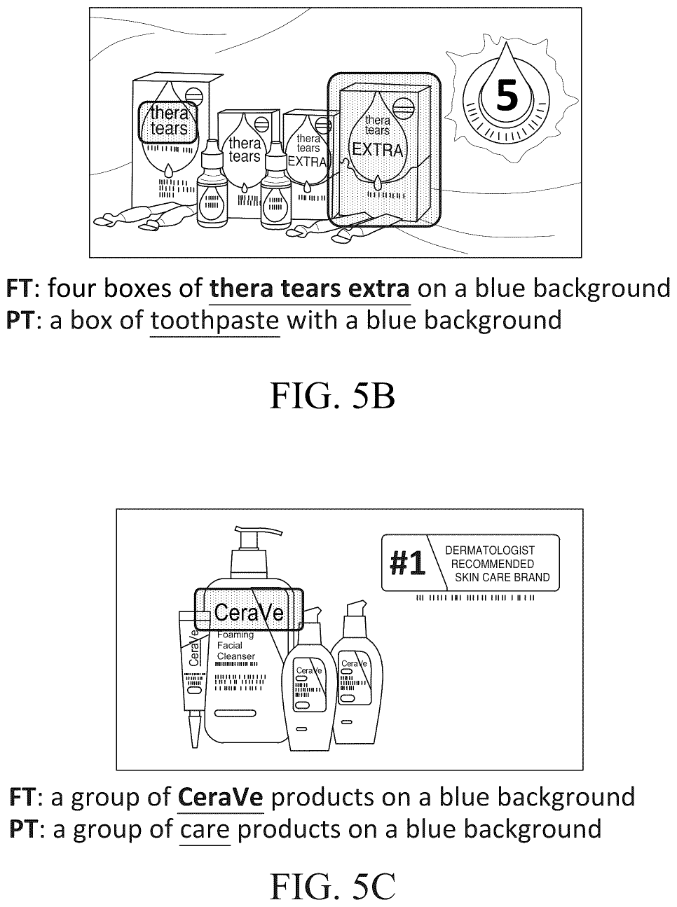

Turning ahead in the drawings, FIG. 5A illustrates a flow chart for a method 500 of training the multimodal GenAI model to generate image alt text having an emphasis on brand and product information. Method 500 is merely exemplary and is not limited to the embodiments presented herein. Method 500 can be employed in many different embodiments or examples not specifically depicted or described herein. In some embodiments, the procedures, the processes, and/or the activities of method 500 can be performed in the order presented. In other embodiments, the procedures, the processes, and/or the activities of method 500 can be performed in any suitable order. In still other embodiments, one or more of the procedures, the processes, and/or the activities of method 500 can be combined or skipped.

In many embodiments, system 300 (FIG. 3), image alt text generation system 310 (FIG. 3), and/or web server 320 (FIG. 3) can be suitable to perform method 500 and/or one or more of the activities of method 500. In these or other embodiments, one or more of the activities of method 500 can be implemented as one or more computing instructions configured to run at one or more processors and configured to be stored at one or more non-transitory computer readable media. Such non-transitory computer readable media can be part of system 300 (FIG. 3). The processor(s) can be similar or identical to the processor(s) described above with respect to computer system 100 (FIG. 1).

In some embodiments, method 500 and other activities in method 500 can include using a distributed network including distributed memory architecture to perform the associated activity. This distributed architecture can reduce the impact on the network and system resources to reduce congestion in bottlenecks while still allowing data to be accessible from a central location.

As shown in FIG. 5A, in many embodiments a test image 510 depicting a test product can be received, such as test image entered by a user using a user device (e.g., user 350 (FIG. 3) using user device 340 (FIG. 3)). In many embodiments, test image 510 can be received as input for an activity 520 of image encoding by an image encoder. In some embodiments, activity 520 can involve creating an embedded image of the test image. In several embodiments, the embedded image output from activity 520 can be used as an input to an activity 530 of generating a query for a large language model by a query transformer. In many embodiments, an input prompt 540 is also used to input to the activity 530, such as a text prompt entered by a user using a user device (e.g., user 350 (FIG. 3) using user device 340 (FIG. 3)). In some embodiments, the activity 530 uses the input prompt 540 and the embedded image output from activity 520 to generate a query for a large language model. In several embodiments, the query is input into activity 550 of generating a test image alt text describing the test image, using the large language model. In some embodiments, the large language model is a vision-language model that has been pre-trained with certain image and text datasets.

In several embodiments, the test image alt text output by activity 550 is provided to activity 560 of comparing the test image alt text to pre-approved image alt text for the test product shown in the test image. In some embodiments, the activity 560 is performed to assess whether brand information and product information appears, and/or is accurate and/or comprehensive and intelligible, in the test image alt text. In certain embodiments, the activity 560 is performed manually by a user, whereas in other embodiments the activity is performed automatically. In several embodiments, the activity 530 performed by the query transformer is tuned on the basis of results of activity 560 of comparing the test image alt text to pre-approved image alt text, to focus the query transformer on brand information and/or product information of the test product shown in the test image. For example, in some embodiments, parameters and/or relative weights set in the query transformer to perform the activity 530 are adjusted on the basis of the result of the comparison performed in activity 560.

According to some embodiments, any one or more of the activities 510-560 are iteratively performed to further tune the query transformer. According to some embodiments, the method 500 of training the multimodal Gen AI model comprises training on pairs of model images (e.g., test images) and image alt text associated therewith. In certain embodiments, training with the pairs of model images and image alt text associated is performed on a pre-trained vision-language model, to fine tune the model by shifting the model attention to product information and brand information. In certain embodiments, any one or more of the activities 510-560 are iteratively performed to tune the query transformer of activity 530, on the basis of the result of the comparison performed in activity 560, without tuning of the image encoder of activity 520 and/or the large language model of activity 550. That is, one or more of the image encoder and large language model may be “frozen” with pre-set parameters that are maintained throughout fine tuning of the model, such that only the query transformer is tuned during the training process. This “freezing” of the image encoder and/or large language model can be implemented, for example, to speed up the fine tuning of the model, by focusing on tuning of the query transformer. According to yet other embodiments, “freezing” of the image encoder and/or large language model can allow for different image encoders and/or large language models to be swapped out for use with the query transformer.

FIGS. 5B and 5C show examples of test images and the test image alt text generated in activity 550 for the images as a part of fine-tuning of the multimodal GenAI model. The “PT” answers show test image alt text generated for the images before fine-tuning of the model, and the “FT” answers show test image alt text generated for the images after fine-tuning of the model. In the example shown in FIG. 5B, the “PT” test image alt text describes the image as “a box of toothpaste with a blue background,” whereas the “FT” test image alt text that is generated to describe the image after fine-tuning of the model describes the image as “four boxes of thera tears extra on a blue background.” The “FT” test image alt text not only corrects the product information (the depicted product is an eye solution, not toothpaste), but also incorporates brand information (“Thera Tears”) into the description. In the example shown in FIG. 5C, the “PT” test image alt text describes the image as “a group of care products on a blue background,” whereas the “FT” test image alt text that is generated to describe the image after fine-tuning of the model describes the image as “a group of Cera Ve products on a blue background.” Similarly, the “FT” test image alt text hones the product information (CeraVe products, as opposed to “care products” more generally), and also incorporates brand information (“CeraVe”) into the description.

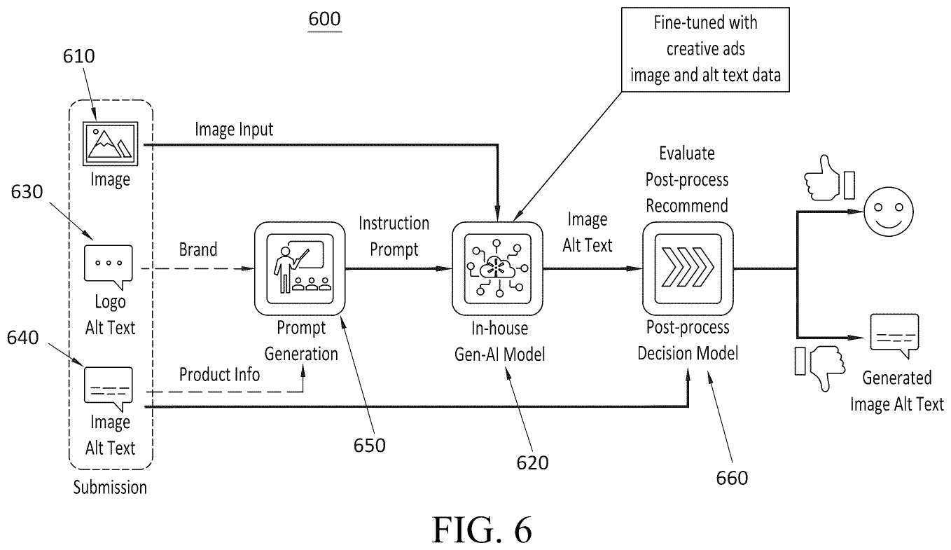

Turning ahead in the drawings, FIG. 6 illustrates a flow chart for a method 600 of generating image alt text, according to one embodiment. Method 600 is merely exemplary and is not limited to the embodiments presented herein. Method 600 can be employed in many different embodiments or examples not specifically depicted or described herein. In some embodiments, the procedures, the processes, and/or the activities of method 600 can be performed in the order presented. In other embodiments, the procedures, the processes, and/or the activities of method 600 can be performed in any suitable order. In still other embodiments, one or more of the procedures, the processes, and/or the activities of method 600 can be combined or skipped.

In many embodiments, system 300 (FIG. 3), image alt text generation system 310 (FIG. 3), and/or web server 320 (FIG. 3) can be suitable to perform method 600 and/or one or more of the activities of method 600. In these or other embodiments, one or more of the activities of method 600 can be implemented as one or more computing instructions configured to run at one or more processors and configured to be stored at one or more non-transitory computer readable media. Such non-transitory computer readable media can be part of system 300 (FIG. 3). The processor(s) can be similar or identical to the processor(s) described above with respect to computer system 100 (FIG. 1).

In some embodiments, method 600 and other activities in method 600 can include using a distributed network including distributed memory architecture to perform the associated activity. This distributed architecture can reduce the impact on the network and system resources to reduce congestion in bottlenecks while still allowing data to be accessible from a central location.

As shown in FIG. 6, in many embodiments, an image 610 depicting a product can be received, such as an image entered by a user using a user device (e.g., user 350 (FIG. 3) using user device 340 (FIG. 3)). For example, the image 610 can be of a product that is being offered for sale on a retail website (e.g., an advertising image), and/or may also include additional image features in addition to the product, such as a background or setting for the product, other objects in addition to the product, and/or persons interacting with the product. In certain embodiments, the image 610 does not include any visible brand information for the product in the image, for example the image is absent logos or other brand-identifying information, or any logos or brand-identifying information that may be present in the image is at least partially or entirely obscured in the image. In many embodiments, the image 610 is input into activity 620 for generating a recommended image alt text. In certain embodiments, the activity 620 is performed by a multimodal GenAI model, such as for example the multimodal GenAI model trained according to method 500 (FIG. 5) to generate image alt text having an emphasis on brand and product information.

In many embodiments, a user-submitted logo alt text 630 can be received, such as such as user-submitted logo alt text entered by a user using a user device (e.g., user 350 (FIG. 3) using user device 340 (FIG. 3)). In certain embodiments, the user-submitted logo alt text can be text submitted by the user that describes the brand of the product (e.g., the brand associated with a graphic or text logo of the product) shown in the input image 610. In many embodiments, a user-submitted image alt text 640 can be received, such as such as user-submitted image alt text entered by a user using a user device (e.g., user 350 (FIG. 3) using user device 340 (FIG. 3)). In certain embodiments, the user-submitted image alt text can be text submitted by the user that describes the input image 610 (e.g., information about the product shown in the input image 610). In certain embodiments, the user-submitted image alt text includes a description of any one or more of product type, product category, product size, product style, product quantity, product cost, product weight, product color, product shape, product specifications, product description, related product information, and product promotional information.

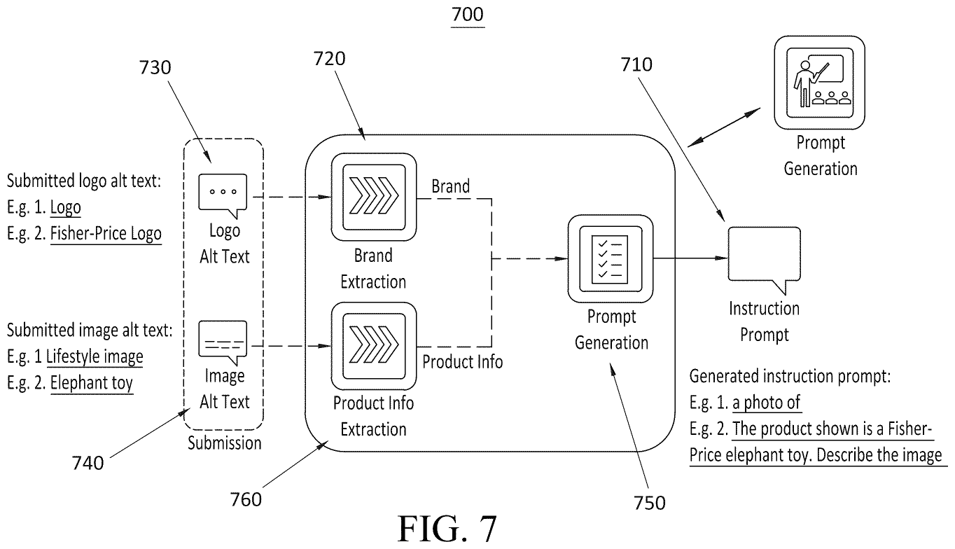

In many embodiments, information relating to the logo alt text 630 and image alt text 640, and/or the logo alt text 630 and image alt text 640 themselves are received as input for an activity 650 of generating an instruction prompt. In certain embodiments, the activity 650 of generating the instruction prompt uses information relating to the logo alt text 630 and the image alt text 640, and/or the logo alt text 630 and image alt text 640 themselves that are input by the user, to generate an instruction prompt for the activity 620 of generating the recommended image alt text describing the product information. In several embodiments, by providing the logo alt text 630 and image alt text 640 to the activity 650, an instruction prompt can be generated that is focused on brand and/or product information for the product that is displayed in the image 610. For example, the instruction prompt generated in activity 650 provides guidance and/or parameters to the activity 620 with respect to generating recommended image alt text that includes the brand and/or product information. In several embodiments, as shown in the method 700 of generating instruction prompts (shown in FIG. 7), brand information and/or product information is extracted from the user-submitted logo alt text 630 and the user-submitted image alt text 640, which brand information and/or product information is used in the generation of the instruction prompt.

In several embodiments, the instruction prompt generated by the activity 650 is used as input into the activity 620 of generating recommended image alt text, along with the image 610 input by the user. In several embodiments, the activity 620 of generating recommended image alt text involves analyzing the image 610 to generate a description thereof, in accordance with the guidance and/or parameters provided by the instruction prompt. In several embodiments, the activity 620 of generating the recommended image alt text will generate image alt text that includes a description of the brand and product information included in the instruction prompt output by the activity 650 of prompt generation.

In several embodiments, the recommended image alt text generated from activity 620 is used as input for activity 660 that can include post-processing of the recommended image alt text to improve the recommended image alt text, and/or evaluation of the recommended image alt text to determine whether to approve the recommended image alt text for use with the image 610. In certain embodiments, the activity 660 also receives as input the user-submitted image alt text 640 input by the user to allow for comparison of the recommended image alt text to the user-submitted image alt text 640, and selection of one of the user-submitted image alt text and recommended image alt text for use with the image. In certain embodiments, the activity 660 can be done manually, such as by manually inputting grammatical and/or corrections or improvements into the recommended image alt text, and/or by manual comparison by the user of the recommended image alt text to the user-submitted image alt text to evaluate whether to approve the recommended image alt text or the user-submitted image alt text, for use with the image 610. In certain embodiments, the recommended image alt text is approved for use with the image 610 when it includes improved brand or product information over the user-submitted image alt text, or is otherwise more comprehensive and/or descriptive of the image 610.

Turning ahead in the drawings, FIG. 7 illustrates a flow chart for a method 700 of generating instruction prompt 710, according to one embodiment. Method 700 is merely exemplary and is not limited to the embodiments presented herein. Method 700 can be employed in many different embodiments or examples not specifically depicted or described herein. In some embodiments, the procedures, the processes, and/or the activities of method 700 can be performed in the order presented. In other embodiments, the procedures, the processes, and/or the activities of method 700 can be performed in any suitable order. In still other embodiments, one or more of the procedures, the processes, and/or the activities of method 700 can be combined or skipped.

In many embodiments, system 300 (FIG. 3), image alt text generation system 310 (FIG. 3), and/or web server 320 (FIG. 3) can be suitable to perform method 700 and/or one or more of the activities of method 700. In these or other embodiments, one or more of the activities of method 700 can be implemented as one or more computing instructions configured to run at one or more processors and configured to be stored at one or more non-transitory computer readable media. Such non-transitory computer readable media can be part of system 300 (FIG. 3). The processor(s) can be similar or identical to the processor(s) described above with respect to computer system 100 (FIG. 1).

In some embodiments, method 700 and other activities in method 700 can include using a distributed network including distributed memory architecture to perform the associated activity. This distributed architecture can reduce the impact on the network and system resources to reduce congestion in bottlenecks while still allowing data to be accessible from a central location.

As shown in FIG. 7, in many embodiments, the method 700 can at least partly correspond to that performed by activity 650 to generate the instruction prompt in the method 600 of generating recommended image alt text of FIG. 6. According to several embodiments, user-submitted logo alt text 730 (e.g., the same as user-submitted logo alt text 630 (FIG. 6)) can be received, such as user-submitted logo alt text entered by a user using a user device (e.g., user 350 (FIG. 3) using user device 340 (FIG. 3)). In certain embodiments, the user-submitted logo alt text can correspond to the user-submitted logo alt text 630 that is received in the method 600 of generating recommended image alt text of FIG. 6. For example, in certain embodiments, the logo alt text 730 is text submitted by the user that describes the brand of the product (e.g., the brand associated with a graphic or text logo of the product) shown in the input image 610 (FIG. 6). Examples of user-submitted logo alt text in FIG. 7 include “Logo” or “Fisher-Price Logo”. In many embodiments, user-submitted image alt text 740 (e.g., the same as user-submitted image alt text 640 (FIG. 6)) can be received, such as user-submitted image alt text entered by a user using a user device (e.g., user 350 (FIG. 3) using user device 340 (FIG. 3)). In certain embodiments, the user-submitted image alt text 740 can correspond to the user-submitted image alt text 640 that is received in the method 600 of generating recommended image alt text of FIG. 6. For example, in certain embodiments, the user-submitted image alt text 740 can be text submitted by the user that describes the input image 610 (e.g., information about the product shown in the input image 610) (FIG. 6). In certain embodiments, the user-submitted image alt text includes a description of any one or more of product type, product category, product size, product style, product quantity, product cost, product weight, product color, product shape, product specifications, product description, related product information, and product promotional information. Examples of user-submitted image alt text in FIG. 7 include “Lifestyle image” and “Elephant toy.”

In many embodiments, the user-submitted logo alt text 730 is used to input into an activity 720 of extracting brand information from the user-submitted logo alt text 730. In certain embodiments, the activity 720 automatically runs an algorithm that evaluates the user-submitted logo alt text 730 to extract brand information therefrom. In many embodiments, the user-submitted image alt text 740 is used to input into an activity 760 of extracting product information from the user-submitted image alt text 740. In certain embodiments, the activity 760 automatically runs an algorithm that evaluates the user-submitted image alt text to extract product information therefrom.

In many embodiments, the brand information output by activity 720, and the product information output by activity 760, are received as input for an activity 750 of generating an instruction prompt 710. In certain embodiments, the combined activities of 720, 760, and 750 of generating the instruction prompt can be used in activity 650 of generating the instruction prompt in the method 600 of generating recommended image alt text as shown in FIG. 6. In one embodiment, the activity 750 of generating the instruction prompt uses brand information extracted by the activity 720 relating to the user-submitted logo alt text 730, and uses product information extracted by the activity 760 relating to the user-submitted image alt text to generate an instruction prompt for use in querying a multimodal GenAI model for generation of recommended image alt text.

In certain embodiments, the instruction prompt generated by activity 750 can be used to query the activity 620 of generating recommended image alt text using the multimodal GenAI model (e.g., the multimodal GenAI model trained in method 500 (FIG. 5A) as shown in FIG. 6. In several embodiments, by extracting the brand information from the user-submitted logo alt text 730 in activity 720, and extracting the product information from the user-submitted image alt text 740 in the activity 760, the instruction prompt can be generated that is focused on brand and/or product information for the product that is displayed in the image, such as the image 610 input as part of the method 600 shown in FIG. 6. For example, the instruction prompt generated in activity 750 can provide guidance and/or parameters to the activity 620 (FIG. 6) to query the multimodal GenAI model to generate recommended image alt text that includes the brand and/or product information. Examples of instruction prompts 710 generated by the activity 750 in FIG. 7 include “a photo of” and “The product shown is a Fisher-Price elephant toy. Describe the image.” According to certain embodiments, the second of these example instruction prompts is more comprehensive and detailed than the first, and includes brand information (Fisher-Price) and product information (elephant toy), and so can be used to query the multimodal GenAI model to generate recommended image alt text that includes this brand and product information.

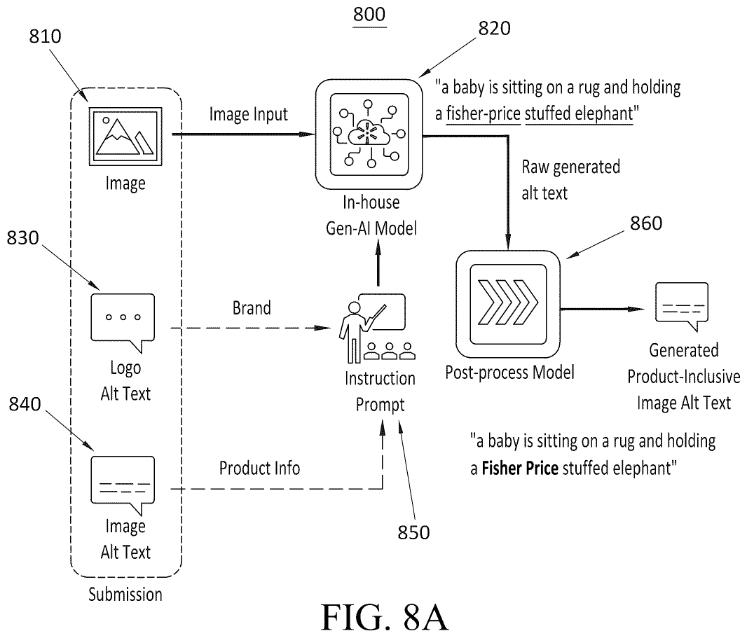

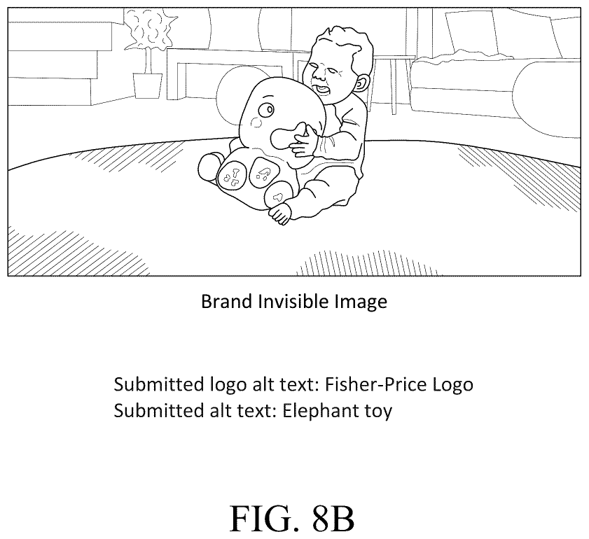

Turning ahead in the drawings, FIG. 8A illustrates a flow chart for a method 800 of post-processing the recommended image alt text, according to one embodiment. Method 800 is merely exemplary and is not limited to the embodiments presented herein. Method 800 can be employed in many different embodiments or examples not specifically depicted or described herein. In some embodiments, the procedures, the processes, and/or the activities of method 800 can be performed in the order presented. In other embodiments, the procedures, the processes, and/or the activities of method 800 can be performed in any suitable order. In still other embodiments, one or more of the procedures, the processes, and/or the activities of method 800 can be combined or skipped.

In many embodiments, system 300 (FIG. 3), image alt text generation system 310 (FIG. 3), and/or web server 320 (FIG. 3) can be suitable to perform method 800 and/or one or more of the activities of method 800. In these or other embodiments, one or more of the activities of method 800 can be implemented as one or more computing instructions configured to run at one or more processors and configured to be stored at one or more non-transitory computer readable media. Such non-transitory computer readable media can be part of system 300 (FIG. 3). The processor(s) can be similar or identical to the processor(s) described above with respect to computer system 100 (FIG. 1).

In some embodiments, method 800 and other activities in method 800 can include using a distributed network including distributed memory architecture to perform the associated activity. This distributed architecture can reduce the impact on the network and system resources to reduce congestion in bottlenecks while still allowing data to be accessible from a central location.

As shown in FIG. 8A, in many embodiments, the method 800 can include activities corresponding to those shown in the methods 600 (FIG. 6) and 700 (FIG. 7), such as the activity 660 of post-processing the recommended image alt text in method 600 (FIG. 6). In many embodiments, an image 810 (e.g., the same as image 610 (FIG. 6) depicting the product can be received, such as an image entered by a user using a user device (e.g., user 350 (FIG. 3) using user device 340 (FIG. 3)). For example, the image 810 can be of a product that is being offered for sale on a retail website (e.g., an advertising image), and/or may also include additional image features in addition to the product, such as a background or setting for the product, other objects in addition to the product, and/or persons interacting with the product. In certain embodiments, the image 810 does not include any visible brand information for the product in the image, for example the image is absent logos or other brand-identifying information, or any logos or brand-identifying information that may be present in the image is at least partially or entirely obscured in the image. In many embodiments, the image 810 is input into activity 820 for generating recommended image alt text. In certain embodiments, the activity 820 is performed by the multimodal GenAI model, such as for example the multimodal GenAI model trained according to method 500 (FIG. 5A) to generate image alt text having an emphasis on brand and product information.

In many embodiments, user-submitted logo alt text 830 (e.g., the same as user-submitted logo alt text 630 (FIG. 6) and/or 730 (FIG. 7)) can be received, such as such as user-submitted logo alt text entered by a user using a user device (e.g., user 350 (FIG. 3) using user device 340 (FIG. 3)). In certain embodiments, the user-submitted logo alt text can be text submitted by the user that describes the brand of the product (e.g., the brand associated with a graphic or text logo of the product) shown in the input image 810. For example, as shown in FIG. 8B, user-submitted logo alt text may be “Fisher-Price Logo”. In many embodiments, user-submitted image alt text 840 (e.g., the same as user-submitted image alt text 640 (FIG. 6) and/or 740 (FIG. 7)) can be received as user-submitted image alt text entered by a user using a user device (e.g., user 350 (FIG. 3) using user device 340 (FIG. 3)). In certain embodiments, the user-submitted image alt text 840 can be text submitted by the user that describes the input image 810 (e.g., information about the product shown in the input image 810). In certain embodiments, the user-submitted image alt text includes a description of any one or more of product type, product category, product size, product style, product quantity, product cost, product weight, product color, product shape, product specifications, product description, related product information, and product promotional information.

In many embodiments, information relating to the logo alt text 830 and image alt text 840, and/or the logo alt text 830 and image alt text 840 themselves are received as input for an activity 850 of generating an instruction prompt. In certain embodiments, the activity 850 of generating the instruction prompt uses information relating to the user-submitted logo alt text 830 and the user-submitted image alt text 840, and/or the user-submitted logo alt text 830 and user-submitted image alt text 840 themselves that are input by the user, to generate the instruction prompt for the activity 820 of generating the recommended image alt text describing the product information. In several embodiments, by providing information about the user-submitted logo alt text 830 and user-submitted image alt text 840 (or the user-submitted logo alt text 830 and user-submitted image alt text 840 themselves) to the activity 850, the instruction prompt can be generated that is focused on brand and/or product information for the product that is displayed in the image 810. For example, the instruction prompt generated in activity 850 provides guidance and/or parameters to the activity 820 with respect to generating recommended image alt text that includes the brand and/or product information. In several embodiments, as shown for example in the method 700 of generating instruction prompts (shown in FIG. 7), brand information and/or product information is extracted from the user-submitted logo alt text 830 and the user-submitted image alt text 840, which brand information and/or product information is used in the generation of the instruction prompt.

In several embodiments, the instruction prompt generated by the activity 850 is used as input into the activity 820 of generating recommended image alt text, along with the image 810 input by the user. In several embodiments, the activity 820 of generating recommended image alt text involves analyzing the image 810 to generate a description thereof, in accordance with the guidance and/or parameters provided by the instruction prompt. In several embodiments, the activity 820 of generating the recommended image alt text will generate image alt text that includes a description of the brand and product information included in the instruction prompt output by the activity 850 of prompt generation.

In several embodiments, the recommended image alt text generated from activity 820 is used as input for activity 860 that can include post-processing of the recommended image alt text to improve the recommended image alt text. In certain embodiments, the activity 860 can be done manually, such as by manually inputting grammatical and/or corrections or improvements into the recommended image alt text. In certain embodiments, the activity 860 is performed to post-process the recommended image alt text to improve any one or more of readability, searchability (e.g., SEO), and accuracy of the recommended image alt text. FIG. 8B shows an example of an image with a product for sale, and specifically a stuffed elephant by Fisher Price that is being held by a baby. Using user-submitted logo alt text “Fisher-Price Logo” and user-submitted image alt text “Elephant toy,” embodiments of the method 800 depicted in FIG. 8A can generate, as an example, recommended image alt text (via activity 820) describing the image as “a baby is sitting on a rug and holding a fisher-price stuffed elephant.” The activity 860 of post-processing the recommended image alt text, according to this example, can post-process this text to capitalize the brand “Fisher Price” and remove the dash between the two words in the brand name, to improve the recommended image alt text, and other improvements can also be performed.

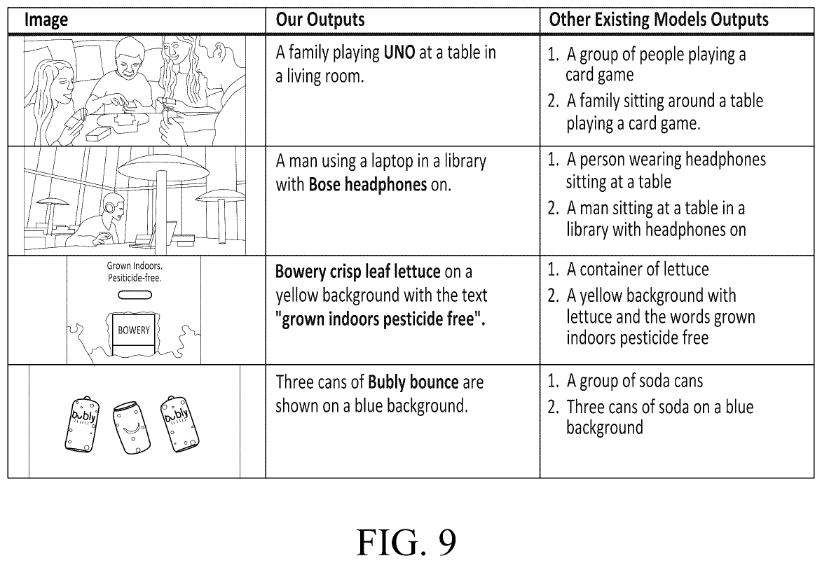

Referring to FIG. 9, a chart comparing example image alt text generated using techniques according to embodiments of the invention, to image alt text using other existing image alt text generation methods, is provided. As can be seen from this chart, the techniques according to embodiments of the invention provide improved incorporation of brand and product information in the generated image alt text, as compared to other existing techniques.

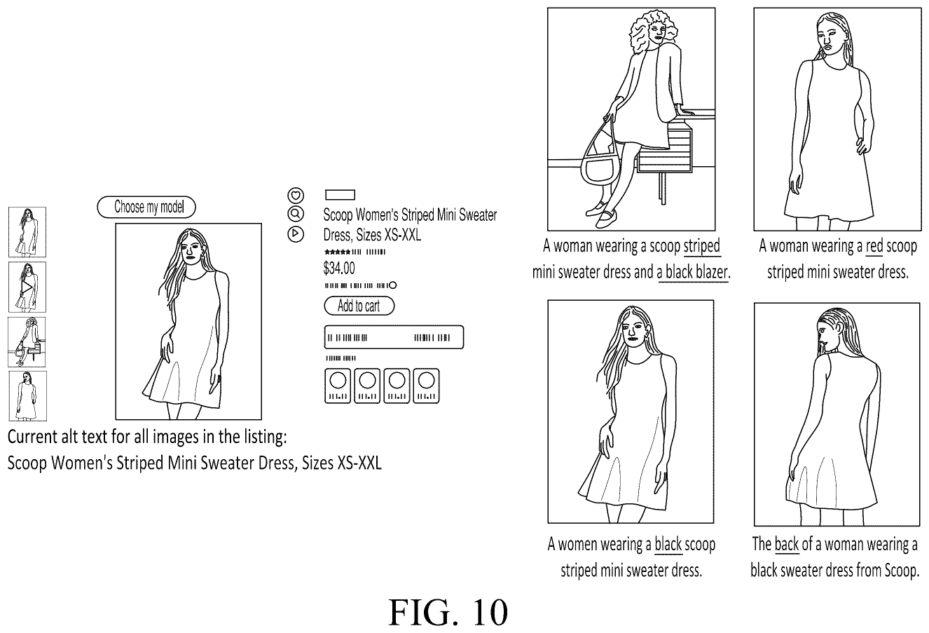

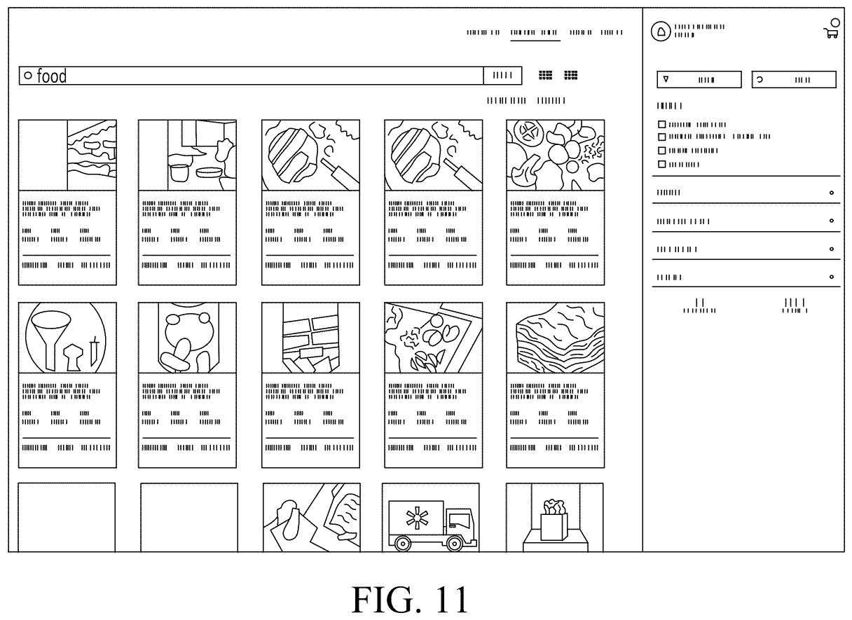

Referring to FIG. 10, an image showing other possible uses for techniques according to embodiments of the invention is provided. In this figure, a listing for a product for sale is displayed, depicting a model in a product corresponding to a black sweater dress. However, the listing also includes multiple further images of different colors of dress, with different backgrounds and even different models. Techniques used in embodiments of the invention can be used to generate informative and/or unique image alt text for the multiple further product images, for example describing the color, size or type of the product, or other features of the image. As another example, techniques according to embodiments of the invention can also be used to create image file names and html links to improve the ability to locate the images and corresponding product in an internet search (SEO). Referring to FIG. 11, an image showing yet another possible use for techniques according to embodiments of the invention is provided. In this figure, an asset library of various images is depicted, where the asset library can include any one or more of product imagery, purchased stock media, and marketing creative assets, among other images. Techniques used in embodiments of the invention can be used to generate informative and/or unique image alt text for the images in the asset library, such as for example to enhance the creative experience of viewing the images, or to improve image search retrieval (SEO).

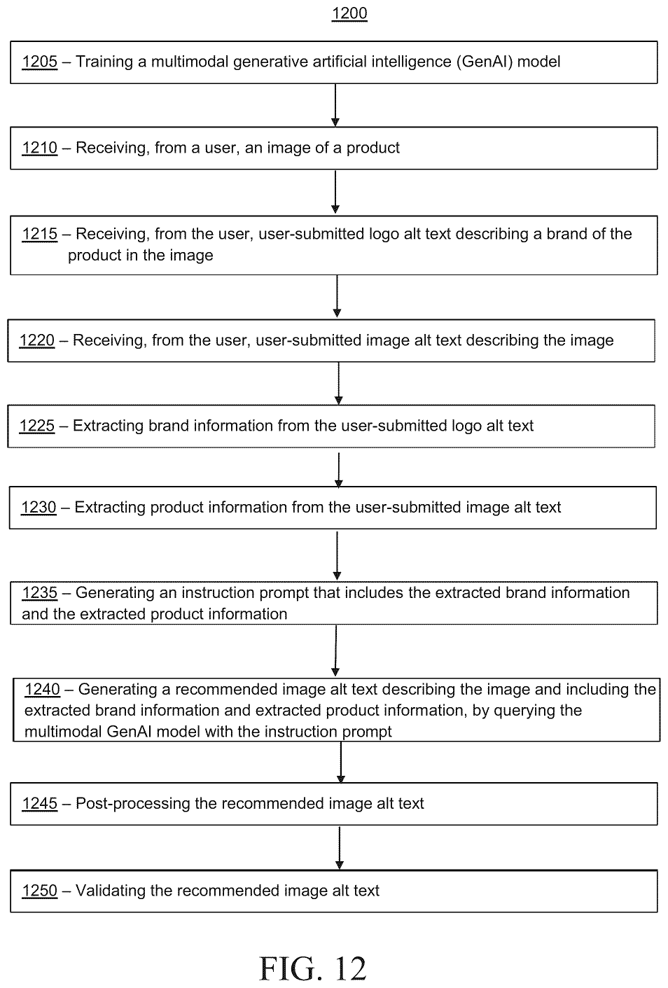

Turning ahead in the drawings, FIG. 12 illustrates a flow chart for a method 1200 of generating image alt text that includes product and/or brand information, according to another embodiment. Method 1200 is merely exemplary and is not limited to the embodiments presented herein. Method 1200 can be employed in many different embodiments or examples not specifically depicted or described herein. In some embodiments, the procedures, the processes, and/or the activities of method 1200 can be performed in the order presented. In other embodiments, the procedures, the processes, and/or the activities of method 1200 can be performed in any suitable order. In still other embodiments, one or more of the procedures, the processes, and/or the activities of method 600 can be combined or skipped.

In many embodiments, system 300 (FIG. 3), image alt text generation system 310 (FIG. 3), and/or web server 320 (FIG. 3) can be suitable to perform method 1200 and/or one or more of the activities of method 1200. In these or other embodiments, one or more of the activities of method 1200 can be implemented as one or more computing instructions configured to run at one or more processors and configured to be stored at one or more non-transitory computer readable media. Such non-transitory computer readable media can be part of system 300 (FIG. 3). The processor(s) can be similar or identical to the processor(s) described above with respect to computer system 100 (FIG. 1).

In some embodiments, method 1200 and other activities in method 1200 can include using a distributed network including distributed memory architecture to perform the associated activity. This distributed architecture can reduce the impact on the network and system resources to reduce congestion in bottlenecks while still allowing data to be accessible from a central location.

Referring to FIG. 12, method 1200 can include an activity 1205 of training a multimodal GenAI model. For example, the activity 1205 of training the multimodal GenAI model can include any of the activities described for method 500 in FIG. 5A. In many embodiments, the activity 1205 of training the multimodal Gen AI model comprises training on pairs of model images and pre-approved image alt text associated therewith. In many embodiments, the training of the multimodal GenAI model comprises receiving a test image of a test product, generating an embedded image from the test image, generating a query for a large language model based on the embedded image and an input prompt, generating a test image alt text describing the test image using a large language model, based on the query, comparing the test image alt text to pre-approved image alt text for the test product shown in the test image, and tuning parameters used in generating the query for the large language model based on a result of comparing the test image alt text to the pre-approved image alt text, to focus the query on brand information and product information of the test product shown in the test image. In certain embodiments, the activity 1205 comprises tuning parameters used in generating the query for the large language model based on the result of comparing the test image alt text to the pre-approved image alt text, without tuning parameters used in generating the embedded image or parameters used in the large language model in generating the test image alt text. In many embodiments, multimodal Gen AI system 313 (FIG. 3) can at least partially perform activity 1205.

In a number of embodiments, the method 1200 can also include an activity 1210 of receiving, from a user, an image of a product. For example, the activity 1210 of receiving, from the user, the image of the product can include receiving an image 610 or 810 as described for method 600 in FIG. 6, or method 800 in FIG. 8A, respectively. The user can be similar or identical to user 350 (FIG. 3). In many embodiments, the image of the product comprises an advertising image for sale of the product on a website, the advertising image optionally including additional image features in addition to the product. In certain embodiments, the image of the product does not include any visible brand information for the product. In many embodiments, communication system 311 (FIG. 3) can at least partially perform activity 1210.

In a number of embodiments, the method 1200 can also include an activity 1215 of receiving, from the user, user-submitted logo alt text describing a brand of the product in the image. For example, the activity 1215 of receiving, from the user, user-submitted logo alt text describing the brand of the product in the image can include receiving logo alt text 630, 730, or 830 as described for method 600 in FIG. 6, method 700 in FIG. 7, or method 800 in FIG. 8A, respectively. Also, in a number of embodiments, the method 1200 can also include an activity 1220 of receiving, from the user, user-submitted image alt text describing the image. For example, the activity 1220 of receiving, from the user, user-submitted image alt text describing the image can include receiving image alt text 640, 740, or 840 as described for method 600 in FIG. 6, method 700 in FIG. 7, or method 800 in FIG. 8A, respectively. In many embodiments, the user-submitted image alt text can include any one or more of the product type, product category, product size, product style, product quantity, product cost, product weight, product color, product shape, product specifications, product description, related product information, and product promotional information. In many embodiments, communication system 311 (FIG. 3) can at least partially perform activity 1215 and/or activity 1220.

In a number of embodiments, the method 1200 can also include an activity 1225 of extracting brand information from the user-submitted logo alt text, and activity 1230 of extracting product information from the user-submitted image alt text. For example, the activity 1225 of extracting brand information from the user-submitted logo alt text can correspond to activity 720 described for method 700 in FIG. 7. As another example, the activity 1230 of extracting product information from the user-submitted image alt text can correspond to activity 760 described for method 700 in FIG. 7. In many embodiments, prompt generation system 312 (FIG. 3) can at least partially perform activity 1225 and/or activity 1230.

In a number of embodiments, the method 1200 can also include an activity 1235 of generating an instruction prompt that includes the extracted brand information and the extracted product information. For example, the activity 1235 of generating an instruction prompt can correspond to activity 650, 750 and/or 850 as described for method 600 in FIG. 6, method 700 in FIG. 7 and/or method 800 in FIG. 8A, respectively. In many embodiments, prompt generation system 312 (FIG. 3) can at least partially perform activity 1225 and/or activity 1230 and/or activity 1235. In a number of embodiments, the method 1200 can also include an activity 1240 of generating a recommended image alt text describing the image and including the extracted brand information and extracted product information, by querying the multimodal generative artificial intelligence (multimodal GenAI) model with the instruction prompt. For example, the activity 1240 of generating recommended image alt text can correspond to activity 620 and/or 820 as described for method 600 in FIG. 6, and/or method 800 in FIG. 8A, respectively. In certain embodiments, one or both of the activity 1235 of generating the instruction prompt, and the activity 1240 of generating the recommended image alt text, are performed after activity 1205 of training the multimodal GenAI model. In certain other embodiments the activity 1205 of training the multimodal GenAI model is performed after the activity 1235 of generating the instruction prompt, but before the activity 1240 of generating the recommended image alt text. In many embodiments, multimodal GenAI system 313 (FIG. 3) can at least partially perform activity 1240.

In a number of embodiments, the method 1200 can also include an activity 1245 of post-processing of the recommended image alt text to improve any one or more of readability, searchability, and accuracy of the recommended image alt text. For example, the activity 1245 of post-processing of the recommended image alt text can correspond to activity 660 and/or 860 as described for method 600 in FIG. 6, and/or method 800 in FIG. 8A, respectively. In many embodiments, image alt text post-processing system 314 (FIG. 3) can at least partially perform activity 1245. In a number of embodiments, the method 1200 can also include an activity 1250 of validating the recommended image alt text. For example, the activity 1250 of validating the recommended image alt text can correspond to activity 660 as described for method 600 in FIG. 6. In certain embodiments, the activity 1250 can include comparing the recommended image alt text generated by the multimodal GenAI model to the user-submitted image alt text to generate a comparison result, and selecting one of the recommended image alt text and the user-submitted image alt text, based on the comparison result. In certain further embodiments, the activity 1250 comprises identifying a number of differences between the recommended image alt text and the multimodal GenAI model to generate the comparison result. In certain embodiments, the activity 1250 comprises selecting one of the recommended image alt text and the user-submitted image alt text, based on the comparison result, by: (i) selecting the recommended image alt text for recommendation to the user when the comparison result indicates the number of differences between the recommended image alt text and the user-input image alt text exceeds a threshold value; or (ii) selecting the user-input image alt text for recommendation to the user when the comparison result indicates the number of differences between the recommended image alt text and the user-input image alt text does not exceed the threshold value. In many embodiments, validation system 315 (FIG. 3) can at least partially perform activity 1250.

In many embodiments, the techniques described herein can provide a practical application and several technological improvements. In some embodiments, the techniques described herein can provide for the efficient and accurate generation of image alt text to describe images, and including product and brand information for the products in the images, even in a case where product information is not visible in an image. The techniques described herein can provide a significant improvement over conventional approaches that fail to take into account input provided by users, such as a user's submitted image alt text and logo alt text, which can include brand and product information that can be extracted to generate a directed instruction prompt to a multimodal GenAI model. In some embodiments, the techniques described herein can leverage a multimodal GenAI model that is trained and that has been fine-tuned for the identification and accurate description of product and brand information for a product displayed in an image, as well as a method for training such a multimodal GenAI model. That is, the techniques can exploit a multimodal GenAI model with enhanced ability to generate descriptions of products that include brand and product information, over conventional approaches. In some embodiments, the techniques described herein can provide improved prompt generation that more accurately prompts a multimodal GenAI model for image alt text that includes brand and product information. The techniques herein can improve the visibility of product images when searched with search engines, and can improve the accessibility of images to users with visual impairment, to provide an improved experience over conventional approaches.

In some embodiments, the techniques described herein can exploit post processing of the generated image alt text, and validation of the image alt text, such as by comparison to a user-submitted image alt text to determine if a number of differences therefrom exceeds a threshold. The techniques can leverage the post-processing and validation techniques to automate selection and recommendation of image alt text to a user.

In a number of embodiments, the techniques described herein can solve a technical problem that arises only within the realm of computers and computer networks, as the generation of image alt text is a concept that does not exist outside the realm of computers or computer networks. Moreover, the techniques described herein can solve a technical problem that cannot be solved outside the context of computers and computer networks. Specifically, the techniques described herein cannot be used outside the context of computer networks, in view of a lack of image alt text associated with electronic images outside the context of computers and computer networks, the inability to utilize multimodal GenAI models without a computer or computer network, among other problems.

Although the methods described above are with reference to the illustrated flowcharts, it will be appreciated that many other ways of performing the acts associated with the methods can be used. For example, the order of some operations may be changed, and some of the operations described may be optional.

In addition, the methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

The foregoing is provided for purposes of illustrating, explaining, and describing embodiments of these disclosures. Modifications and adaptations to these embodiments will be apparent to those skilled in the art and may be made without departing from the scope or spirit of these disclosures.

Although generating image alt text has been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-12 may be modified, and that the foregoing discussion of certain of these embodiments does not necessarily represent a complete description of all possible embodiments. For example, one or more of the procedures, processes, or activities of FIGS. 5A, 6, 7, 8A and 12 may include different procedures, processes, and/or activities and be performed by many different modules, in many different orders, and/or one or more of the procedures, processes, or activities of FIGS. 5A, 6, 7, 8A and 12 may include one or more of the procedures, processes, or activities of another different one of FIGS. 5A, 6, 7, 8A and 12. As another example, the systems within system 300 (FIG. 3) can be interchanged or otherwise modified.

As a further example, the systems and methods described herein an include guardrails to stop or at least reduce inappropriate content from being published. In some embodiments, a text brand safety model can be used. In these embodiments, the model can be part of or a subsequent component or functionality of validation system 315 (FIG. 3) and/or of activity 1250 (FIG. 12) of validating the recommended image alt text. As an example, the selected recommended image alt text can be validated by a text brand safety system. A natural language processing (NLP)-based guardrail system can be used to detect words, phrases, and sentences related to inappropriate content, such as profanity, alcohol, violence, adult content, hateful content, etc. If inappropriate content is detected, the model can prevent the output of the image alt text relating to inappropriate content, and can raise an error flag for further intervention.

Replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A system comprising:
a processor; and
a non-transitory computer-readable media storing computing instructions that, when executed on the processor, cause the processor to perform:
receiving, from a user, an image of a product;
receiving, from the user, user-submitted logo alt text describing a brand of the product in the image;
receiving, from the user, user-submitted image alt text describing the image;
extracting brand information from the user-submitted logo alt text;
extracting product information from the user-submitted image alt text;
generating an instruction prompt that includes the brand information, as extracted, and the product information, as extracted; and
generating a recommended image alt text describing the image and including the brand information, as extracted, and the product information, as extracted, by querying a multimodal generative artificial intelligence (multimodal GenAI) model with the instruction prompt.

2. The system of claim 1, wherein receiving, from the user, the user-submitted image alt text describing the image comprises:
receiving the user-submitted image alt text including any one or more of product type, product category, product size, product style, product quantity, product cost, product weight, product color, product shape, product specifications, product description, related product information, and product promotional information.

3. The system of claim 1, wherein receiving, from the user, the image of the product comprises:
receiving an advertising image for sale of the product on a website, the advertising image optionally including additional image features in addition to the product.

4. The system of claim 1, wherein receiving, from the user, the image of the product comprises:
receiving the image of the product without any visible brand information in the image of the product.

5. The system of claim 1, wherein the computing instructions, when executed on the processor, further cause the processor to perform:
validating the recommended image alt text generated by the multimodal GenAI model, by:
comparing the recommended image alt text generated by the multimodal GenAI model to the user-submitted image alt text to generate a comparison result; and
selecting one of the recommended image alt text or the user-submitted image alt text, based on the comparison result.

6. The system of claim 5, wherein:
validating the recommended image alt text generated by the multimodal GenAI model further comprises:
identifying a number of differences between the recommended image alt text and the multimodal GenAI model to generate the comparison result; and
selecting the one of the recommended image alt text or the user-submitted image alt text, based on the comparison result comprises:
selecting the recommended image alt text for recommendation to the user when the comparison result indicates the number of differences between the recommended image alt text and the user-submitted image alt text exceeds a threshold value; or
selecting the user-submitted image alt text for recommendation to the user when the comparison result indicates the number of differences between the recommended image alt text and the user-submitted image alt text does not exceed the threshold value.

7. The system of claim 1 wherein the computing instructions, when executed on the processor, further cause the processor to perform:
post-processing of the recommended image alt text to improve any one or more of readability, searchability, and accuracy of the recommended image alt text.

8. The system of claim 1, wherein the computing instructions, when executed on the processor, further cause the processor to perform:
training the multimodal GenAI model on pairs of model images and pre-approved image alt text associated therewith, before querying of the multimodal GenAI model with the instruction prompt.

9. The system of claim 8, wherein training the multimodal GenAI model on the pairs of model images and pre-approved image alt text associated therewith comprises:
receiving a test image of a test product;
generating an embedded image from the test image;
generating a query for a large language model based on the embedded image and an input prompt;
generating a test image alt text describing the test image using the large language model, based on the query;
comparing the test image alt text to pre-approved image alt text for the test product shown in the test image; and
tuning parameters used in generating the query for the large language model based on a result of comparing the test image alt text to the pre-approved image alt text for the test product shown in the test image, to focus the query on brand information and product information of the test product shown in the test image.

10. The system of claim 9, wherein tuning the parameters comprises:
tuning the parameters used in generating the query for the large language model based on the result of comparing the test image alt text to the pre-approved image alt text for the test product shown in the test image, without tuning parameters used in generating the embedded image or parameters used in the large language model in generating the test image alt text.

11. A method implemented via execution of computing instructions configured to run at a processor, the method comprising:
receiving, from a user, an image of a product;
receiving, from the user, user-submitted logo alt text describing a brand of the product in the image;
receiving, from the user, user-submitted image alt text describing the image;
extracting brand information from the user-submitted logo alt text;
extracting product information from the user-submitted image alt text;
generating an instruction prompt that includes the brand information, as extracted, and the product information, as extracted;
generating a recommended image alt text describing the image and including the brand information, as extracted, and the product information, as extracted, by querying a multimodal generative artificial intelligence (multimodal GenAI) model with the instruction prompt; and
validating the recommended image alt text generated by the multimodal GenAI model.

12. The method of claim 11, wherein receiving, from the user, the user-submitted image alt text describing the image comprises:
receiving the user-submitted image alt text including any one or more of product type, product category, product size, product style, product quantity, product cost, product weight, product color, product shape, product specifications, product description, related product information, and product promotional information.

13. The method of claim 11, wherein receiving, from the user, the image of the product comprises at least one of:
receiving an advertising image for sale of the product on a website, the advertising image optionally including additional image features in addition to the product; or
receiving the image of the product without any visible brand information in the image of the product.

14. The method of claim 11, wherein:
validating the recommended image alt text generated by the multimodal GenAI model comprises:
comparing the recommended image alt text generated by the multimodal GenAI model to the user-submitted image alt text to generate a comparison result; and
selecting one of the recommended image alt text or the user-submitted image alt text, based on the comparison result.

15. The method of claim 14, wherein:
validating of the recommended image alt text generated by the multimodal GenAI model further comprises:
identifying a number of differences between the recommended image alt text and the multimodal GenAI model to generate the comparison result; and
selecting the one of the recommended image alt text or the user-submitted image alt text, based on the comparison result, comprises:
selecting the recommended image alt text for recommendation to the user when the comparison result indicates the number of differences between the recommended image alt text and the user-submitted image alt text exceeds a threshold value; or
selecting the user-submitted image alt text for recommendation to the user when the comparison result indicates the number of differences between the recommended image alt text and the user-submitted image alt text does not exceed the threshold value.

16. The method of claim 11, wherein the method further comprises at least one of:
post-processing of the recommended image alt text to improve any one or more of readability, searchability, or accuracy of the recommended image alt text; or
training the multimodal GenAI model on pairs of model images and pre-approved image alt text associated therewith, before querying of the multimodal GenAI model with the instruction prompt.

17. The method of claim 16, wherein training the multimodal GenAI model on the pairs of model images and pre-approved image alt text associated therewith comprises:
receiving a test image of a test product;
generating an embedded image from the test image;
generating a query for a large language model based on the embedded image and an input prompt;
generating a test image alt text describing the test image using the large language model, based on the query;
comparing the test image alt text to pre-approved image alt text for the test product shown in the test image; and
tuning parameters used in generating the query for the large language model based on a result of comparing the test image alt text to the pre-approved image alt text for the test product shown in the test image, to focus the query on brand information and product information of the test product shown in the test image.

18. The method of claim 17, wherein tuning the parameters comprises:
tuning the parameters used in generating the query for the large language model based on the result of comparing the test image alt text to the pre-approved image alt text for the test product shown in the test image, without tuning parameters used in generating the embedded image or parameters used in the large language model in generating the test image alt text.

19. A non-transitory computer readable storage medium storing computing instructions, the computing instructions, when run on a processor, causing the processor to perform operations comprising:
receiving, from a user, an image of a product;
receiving, from the user, user-submitted logo alt text describing a brand of the product in the image;
receiving, from the user, user-submitted image alt text describing the image;
extracting brand information from the user-submitted logo alt text;
extracting product information from the user-submitted image alt text;
generating an instruction prompt that includes the brand information, as extracted, and the product information, as extracted;
generating a recommended image alt text describing the image and including the brand information, as extracted, and the product information, as extracted, by querying a multimodal generative artificial intelligence (multimodal GenAI) model with the instruction prompt; and
validating the recommended image alt text generated by the multimodal GenAI model by:
comparing the recommended image alt text generated by the multimodal GenAI model to the user-submitted image alt text to generate a comparison result; and
selecting one of the recommended image alt text or the user-submitted image alt text, based on the comparison result.

20. The non-transitory computer readable storage medium of claim 19, wherein:
validating of the recommended image alt text generated by the multimodal GenAI model further comprises:
identifying a number of differences between the recommended image alt text and the multimodal GenAI model to generate the comparison result; and
selecting the one of the recommended image alt text or the user-submitted image alt text, based on the comparison result comprises:
selecting the recommended image alt text for recommendation to the user when the comparison result indicates the number of differences between the recommended image alt text and the user-submitted image alt text exceeds a threshold value; or
selecting the user-submitted image alt text for recommendation to the user when the comparison result indicates the number of differences between the recommended image alt text and the user-submitted image alt text does not exceed the threshold value.
